(19) United States
(12) Patent Application Publication
(10) Pub. No.: US 2008/0032909 A1
(43) Pub. Date: Feb. 7, 2008

(54) Compact fluid laundry detergent composition

(76) Inventors: Francesco de Buzzaccarini, Breendonk (BE); Ann De Wree, Oost-Vlaanderen (BE); Steven Jozef Louis Coosemans, Kampenhout (BE); Mehmet Tugrul Ergelen, Cincinnati, OH (US); Filip Dominique Hubert Vangeel, Vilvoorde (BE)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 11/799,800

(22) Filed: May 3, 2007

Related U.S. Application Data
(60) Provisional application No. 60/798,214, filed on May 5, 2006.

(51) Int. Cl. C11D 17/08

(52) U.S. Cl. 510/293

(57) ABSTRACT

The present invention relates to articles of commerce for laundering, storing and dispensing liquid compositions in contact therewith.

### CROSS REFERENCE TO RELATED APPLICATION

This application claims the benefit of U.S. Provisional Application Ser. No. 60/798,214, filed May 5, 2006.

### FIELD OF THE INVENTION

The present invention relates to articles of commerce for laundering, storing and dispensing liquid compositions.

### BACKGROUND OF THE INVENTION

Fluid laundry products, such as liquids and gels are preferred by many consumers over solid detergent forms. Many consumers also seek to conserve resources and eliminate waste without wishing to sacrifice the performance of their laundry detergent product. Moreover in certain countries, disposing of bulky waste packaging, e.g., plastic containers, requires troublesome recycling steps such as waste sorting, and is costly to the consumer. Consequently, there is high interest in concentrated or so-called compact laundry products.

Compaction of fluid laundry detergents is technically problematic. For example, the reduction of the water and/or solvent content generally increases fluid laundry detergent viscosity. If left uncontrolled, this increase in viscosity upon compaction leads to problems such as increased difficulty in measurable dispensing, phase separation, poor dissolution in use, and the like. Overly viscous products may fail to dispense from containers or create mess when dispensed. On the other hand, compositions with very low viscosities are very often not practical for delivering suitable levels of cleaning ingredients, nor do they connote good value to the consumer.

Solving the problem of providing an article of commerce comprising a compact fluid laundry detergent and a dispensing container requires interdisciplinary collaboration between formulators and packaging engineers since the product formulation and the dispensing container options form a bewildering array and are intimately linked. For example, an overly viscous fluid laundry detergent may be designed by the formulator to have good cleaning performance, but then may become messy or even impossible to dispense in a measuring cup by volume measurement because the compact fluid detergent distributes itself unevenly in a dispensing cup thereby making it difficult to read or estimate the volume dispensed. On the other hand, packaging solutions provided by the package engineer without regard to properties of the formulation are often found to be unworkable.

Consequently, the need remains for a concentrated or compact fluid laundry detergent that is comparable in performance to existing noncompact or dilute laundry detergent. Ideally any such comparable concentrated or compact fluid laundry detergent will be presented in a fashion that is easy to use and which is aesthetically appealing to consumers.

### SUMMARY OF THE INVENTION

One aspect of the invention relates to an article of commerce for laundering comprising:
(a) a compact fluid laundry composition comprising a sum of water and non-aminofunctional solvent of from about 5% to about 45%, by weight of the composition; and
(b) a water-insoluble container releasably storing said compact fluid laundry detergent composition;
wherein said composition has a neat viscosity, Vₙ, of from about 1,000 cps to about 10,000 cps as measured at 20 s⁻¹, and a diluted viscosity, V_{d}, that is less than or equal to about 0.5Vₙ, as measured at 20 s⁻¹.

Another aspect of the invention relates to an article of commerce for laundering, comprising:
(a) a compact fluid laundry detergent comprising:
(i) at least about 10%, by weight of the composition, of surfactant;
(ii) at least about 0.05%, by weight of the composition, of perfume;
(iii) from about 1% to about 30%, by weight of the composition, of water;
(iv) from about 1% to about 15%, by weight of the composition, of non-aminofunctional solvent;
provided the sum of the water and the non-aminofunctional solvent, by weight of the composition, is from about 5% to 40%; by weight of the composition, and the composition has a neat viscosity, Vₙ, of from about 1000 cps to about 10,000 cps as measured at 20 s⁻¹, and a diluted viscosity, V_{d}, that is less than or equal to about 0.5Vₙ, as measured at 20 s⁻¹; and
(b) a water insoluble container in direct contact with and releasably storing the compact fluid laundry detergent composition.

Another aspect of the invention relates to an article of commerce for laundering, storing and dispensing liquid compositions in contact therewith, comprising:
(a) a compact fluid laundry detergent composition comprising:
(i) from about 20% to about 50%, by weight of the composition, of surfactant selected from the group consisting of anionic surfactants, nonionic surfactants and mixtures thereof;
(ii) from about 0.05% to about 3%, by weight of the composition, perfume;
(iii) from about 5% to about 30%, by weight of the composition, water;
(iv) from about 3% to about 10%, by weight of the composition, of non-aminofunctional solvent;
(v) from about 7% to about 20%, by weight of the composition, soap; and
(vi) from about 0% to about 1%, by weight of the composition, of hydtrotropes and/or externally structuring thickeners;
(vii) from about 0% to about 5%, by weight of the composition, of amine oxide and/or betaine;
wherein the sum of the water and the non-aminofunctional solvent is at least about 15% to about 35%, by weight of the composition, and the compact fluid laundry detergent has a neat viscosity, Vₙ, of from about 1000 cps to about 10,000 cps as measured at 20 s⁻¹, and a diluted viscosity, V_{d}, that is less than or equal to about 0.5Vₙ, as measured at 20 s⁻¹; and
(b) a water insoluble container in direct contact with and releasably storing the compact fluid laundry detergent composition.

### BRIEF DESCRIPTION OF THE DRAWINGS

In the accompanying drawings:

FIG. 1 is an illustrative example of a front view of one possible water insoluble container.

FIG. 2 is a section of the water insoluble container of FIG. 1.

FIG. 3 is an illustrative example of a front view of another possible water insoluble container.

FIG. 4 an exploded view of the water insoluble container of FIG. 3.

FIG. 5 is a section of the water insoluble container of FIG. 3 showing the valve in the closed position.

FIG. 6 is a section of the valve of the water insoluble container of FIG. 3.

FIG. 7 is a section of the water insoluble container of FIG. 3 showing the valve in the open position.

FIG. 8 is an illustrative example of the water insoluble container illustrated in FIG. 3 being gripped by a human hand.

FIG. 9 is an illustrative example of another water insoluble container.

FIG. 10 is an illustrative example of yet another water insoluble container.

### DETAILED DESCRIPTION OF THE INVENTION

Article of Commerce—In one embodiment, the present invention is directed to an article of commerce for laundering, storing and dispensing liquid compositions, comprising a compact fluid laundry detergent and a water insoluble container in direct contact with and releasably storing the compact fluid laundry detergent.

Compact Fluid Laundry Detergent Composition—As used herein, “compact fluid laundry detergent composition” refers to any laundry treatment composition comprising a fluid capable of wetting and cleaning fabric e.g., clothing, in a domestic washing machine. The composition can include solids or gases in suitably subdivided form, but the overall composition excludes product forms which are nonfluid overall, such as tablets or granules. Compositions which are overall gases are also excluded. The compact fluid detergent compositions have densities in the range from about 0.9 to about 1.3 grams, more specifically from about 1.00 to about 1.10 grams per cubic centimeter, excluding any solid additives but including any bubbles, if present.

Examples of compact fluid laundry detergent compositions include heavy-duty liquid laundry detergents for use in the wash cycle of automatic washing-machines, liquid finewash and liquid color care detergents such as those suitable for washing delicate garments, e.g., those made of silk or wool, either by hand or in the wash cycle of automatic washing-machines. The corresponding compositions having flowable yet stiffer consistency, known as gels or pastes, are likewise encompassed. The rheology of shear-thinning gels is described in more detail in the literature, see for example WO04027010A1 Unilever.

In general, the compact fluid laundry detergent compositions herein may be isotropic or non-isotropic. However, for some specific embodiments, they do not generally split into separate layers such as phase split detergents described in the art. One illustrative composition is non-isotropic and on storage is either (i) free from splitting into two layers or, (ii) if the composition splits into layers, a single major layer is present and comprises at least about 80% by weight, more specifically more than about 90%, even more specifically more than about 95% of the composition. Other illustrative compositions are isotropic.

As used herein, when a composition and/or method of the present invention is “substantially free” of a specific ingredient(s) it is meant that specifically none, or in any event no functionally useful amount, of the specific ingredient(s) is purposefully added to the composition. It is understood to one of ordinary skill in the art that trace amounts of various ingredient(s) may be present as impurities. For avoidance of doubt otherwise, “substantially free” shall be taken to mean that the composition contains less than about 0.1%, specifically less than 0.01%, by weight of the composition, of an indicated ingredient.

In one embodiment, the compact fluid laundry detergent is substantially free from abrasives, bleaches and or organic diamines.

In one embodiment, the compact fluid laundry detergent compositions thin on dilution, possess specified high-shear undiluted and diluted viscosities, and specifically are shear thinning having specified low-shear and high-shear neat product viscosities. In this embodiment, the water insoluble containers are specially adapted so that together the compact fluid laundry detergent compositions and the water insoluble containers, as incorporated in the articles, promote good consumer acceptance e.g., controllable non-messy dosing, and ensure dissolution and effective working of the compositions for laundering fabrics.
(i) Surfactant—The compositions and methods of the present invention comprise one or more surface active agents (surfactants). In one embodiment, the surfactant is selected from at least partially water soluble, typically fully water soluble surfactants having a “detersive” or cleaning effect attributable to interfacial tension reduction at interfaces.

In another embodiment, the surfactants are selected from anionic surfactants, nonionic surfactants, cationic surfactants, amphoteric surfactants, zwitterionic surfactants, soap and mixtures thereof.

The surfactant comprises at least about 10%, specifically from more than 10% to about 75%, more specifically from about 20% to about 70%, even more specifically from about 40% to about 60%, by weight of the fluid laundry detergent compositions.

In one embodiment, the surfactants are substantially linear.

In another embodiment, the compact fluid laundry detergent composition is internally structured by a surfactant, and the fluid laundry detergent has the physical form of a flowable liquid, gel or paste.

In one embodiment, the surfactant comprises less than about 5%, specifically from about 0% to less than about 5%, by weight of the composition, more specifically substantially free of amine oxide and/or amphoteric surfactant, such as C8-C18 betaine.

Illustrative examples of surfactants useful herein are described in U.S. Pat. No. 3,664,961, Norris, issued May 23, 1972, U.S. Pat. No. 3,919,678, Laughlin et al., issued Dec. 30, 1975, U.S. Pat. No. 4,222,905, Cockrell, issued Sep. 16, 1980, in U.S. Pat. No. 4,239,659, Murphy, issued Dec. 16, 1980, U.S. Pat. No. 4,285,841, Barrat et al, issued Aug. 25, 1981, U.S. Pat. No. 4,284,532, Leikhim et al, issued Aug. 18, 1981, U.S. Pat. No. 4,285,841, U.S. Pat. No. 3,919,678 and in U.S. Pat. Nos. 2,220,099 and 2,477,383. Surfactants generally are well known, being described in more detail in Kirk Othmer's Encyclopedia of Chemical Technology, 3rd Ed., Vol. 22, pp. 360-379, “Surfactants and Detersive Systems”, McCutcheon's, Detergents & Emulsifiers, by M.C. Publishing Co., (North American edition 1997), Schwartz, et al., Surface Active Agents, Their Chemistry and Technology, New York: Interscience Publishers, 1949; and further information and examples are given in “Surface Active Agents and Detergents” (Vol. I and II by Schwartz, Perry and Berch). See also Surfactant Science Series, Volumes 67 and 129, published by Marcel Dekker, NY, pertaining to liquid detergents and therein especially the chapters pertaining to heavy-duty liquid laundry detergents.

Nonionic Surfactant—In one embodiment, the compositions and methods of the present invention may contain a nonionic surfactant or a mixture of surfactants wherein a nonionic surfactant is an optional component. Mixtures of two or more surfactants, including two or more nonionic surfactants, can be used.

Illustrative examples of suitable nonionic surfactants include: alcohol ethoxylates (e.g. Neodol 25-9 from Shell Chemical Co.), alkyl phenol ethoxylates (e.g. Tergitol NP-9 from Union Carbide Corp.), alkylpolyglucosides (e.g. Glucapon 600CS from Henkel Corp.), polyoxyethylenated polyoxypropylene glycols (e.g. Pluronic L-65 from BASF Corp.), sorbitol esters (e.g. Emsorb 2515 from Henkel Corp.), polyoxyethylenated sorbitol esters (e.g. Emsorb 6900 from Henkel Corp.), alkanolamides (e.g. Alkamide DC212/SE from Rhone-Poulenc Co.), and N-alkypyrrolidones (e.g. Surfadone LP-100 from ISP Technologies Inc.); and combinations thereof. Additional, illustrative suitable nonionic surfactants are those disclosed in U.S. Pat. Nos. 4,316,812 and 3,630,929.

Nonionic surfactant, when present in the composition may be present in the amount of from about 0.01% to about 70%, specifically from about 1% to about 40%, more specifically from about 5% to about 20%, by weight of the composition.

Anionic Surfactants—As used herein, the term “anionic surfactant” refers to an anionic surfactant other than soap. The compositions and methods of the present invention contain an anionic surfactant as the essential surfactant when no other surfactant is present, or a mixture of surfactants wherein an anionic surfactant is an optional component. Mixtures of two or more surfactants, including two or more anionic surfactants, or mixtures thereof with nonionic surfactants can be used.

Preferred anionic surfactants include LAS, AES (sometimes termed SLES), MES and mixtures thereof.

For formula accounting purposes, it is useful to note that LAS is normally formulated into the compositions in acid, i.e., HLAS, form, and is thereafter neutralized or at least partially neutralized in-situ so as to form NaLAS, KLAS, alkanolammonium LAS and the like. Other common anionic surfactants are typically formulated in pre-neutralized form.

Illustrative examples of suitable anionic surfactants includes: linear alkyl benzene sulfonates (e.g. Vista C-500 commercially available from Vista Chemical Co.), branched linear alkyl benzene sulfonates (e.g. MLAS), alkyl sulfates (e.g. Polystep B-5 commercially available from Stepan Co.), branched alky sulfates, alkyl alkoxysulfates (e.g. Standapol ES-3 commercially available from Stepan Co.), alpha olefin sulfonates (e.g. Witconate AOS commercially available from Witco Corp.), alpha sulfo methyl esters (e.g. Alpha-Step MCp-48 commercially available from Stepan Co.) and isethionates (e.g. Jordapon Cl commercially available from PPG Industries Inc.), and combinations thereof.

The anionic surfactants may have any suitable cation as counterion. Mixtures of cations are also possible. Illustrative examples of suitable cations for the anionic surfactants include, sodium, potassium, ammonium, substituted ammonium, amino functional cations, such as alkanolammonium and the like, and the like and mixtures thereof. In one embodiment, the surfactant is free of non-alkanolfunctionalised monoammonium and diammonium cations.

In one embodiment, a portion of the anionic surfactants present in the composition and methods of the present invention may be neutralized in situ, i.e. during the preparation of the compact fluid laundry detergent composition a portion of the anionic surfactant is added in its acid or non neutralized form, for example, the acid or non neutralized form of alkyl benzene sulfonate is alkyl benzenesulfonic acid, and then non neutralized anionic surfactant is either neutralized with a neutralizer, such as NaOH, Monoethanolamine, diethanoamine and the like, already present in the composition, or one that has been added subsequent to the addition of the non neutralized anionic surfactant. In another embodiment, the non neutralized anionic surfactant is either neutralized with a neutralizer immediately prior to addition to the composition. Additional information on suitable neutralizers may be found herein.

Anionic surfactant, when present in the composition may be present in the amount of from about 0.01% to about 70%, more specifically from about 10% to about 50%, even more specifically from about 20% to about 40%, by weight of the detergent composition.

Ratio of Anionic Surfactant to Nonionic Surfactant—In one embodiment, of compositions and methods of the present invention, the weight ratio of the anionic surfactant to the nonionic surfactant from about 1:1 to about 5:1, more specifically greater than about 2:1 to about 5:1, the surfactant comprises from about 10% to about 50%, more specifically from about 20% to about 40%, by weight of the composition, of anionic surfactant and comprises from about 5% to about 40%, more specifically from about 10% to about 30%, by weight of the composition, of soap.

Soap—Soap as defined herein includes fatty acids and soluble salts thereof. Fatty acids and/or soaps or their derivatives are known to possess multiple functionalities in detergents, acting as surfactants, builders, thickeners, foam suppressors etc. Therefore, for avoidance of doubt, for formula accounting purposes and in preferred embodiments herein, soaps and fatty acids are listed separately. Moreover, soaps are commonly neutralized or partially neutralized in-situ in the formulation using neutralizers such as sodium hydroxide, potassium hydroxide and/or alkanolamines such as MEA.

The soap may have any suitable cation as counterion. Mixtures of cations are also possible. Illustrative examples of suitable cations for the soap include, sodium, potassium, ammonium, substituted ammonium, amino functional cations, such as alkanolammonium and the like, and the like and mixtures thereof. In one embodiment, the soap is free of non-alkanolfunctionalised monoammonium and diammonium cations.

Any soluble soap or fatty acid is suitable for use herein, including, lauric, myristic, palmitic stearic, oleic, linoleic, linolenic acid, and mixtures thereof. Naturally obtainable fatty acids, which are usually complex mixtures, are also suitable (such as tallow, coconut, and palm kernel fatty acids). In one embodiment, from about 10% to about 25%, by weight of the composition, of fatty acid may be present in the composition.

In one embodiment, the soap has a degree of neutralization of greater than about 50%. In another embodiment, the surfactant comprises from about 0% to less than about 40%, by weight of the composition, of soap.

Cationic and/or amine oxide and/or zwitterionic and/or amphoteric surfactants—Suitable cationic surfactants are described in Surfactant Science Series, Vol. 67, Ed. Kuo Yann Lai, published by Marcel Dekker, NY, and in US 2003/0199414 A1 at Col. 9 [135]-[137]. Suitable levels of cationic surfactant, when present in the compositions are from about 0.01% to about 20%, specifically from about 1% to about 10%, more specifically from about 2% to about 5%, by weight of the composition. Alternatively amine oxide surfactants such as the C8-C18 alkyldimethylamine-N-oxides, C8-C18 zwitterionic surfactants, C8-C18 amphoteric surfactants and/or C8-C18 alkylamidopropylamine surfactants (APA) may be used at similar levels. Mixtures of such surfactants can also be used.

(ii) Perfumes—One specific adjunct is perfume. As used herein “perfume” refers in its broadest sense to include any substance that diffuses or imparts an agreeable or attractive scent and includes pro-perfume. Perfumes and perfumery ingredients useful in the present compositions and processes comprise a wide variety of natural and synthetic chemical ingredients, including, but not limited to, aldehydes, ketones, esters, enduring perfume ingredients, blooming perfume ingredients, low odor detection threshold perfume ingredients, natural perfume oil ingredient, and the like. In one specific embodiment, the perfume comprises at least one essential oil. In another specific embodiment, the perfume comprises an extract. Also included are various natural extracts and essences which can comprise complex mixtures of ingredients, such as orange oil, lemon oil, rose extract, lavender, musk, patchouli, balsamic essence, sandalwood oil, pine oil, cedar, and the like. Finished perfumes can comprise extremely complex mixtures of such ingredients. Additional information on perfumes and components thereof can be found in U.S. Patent Application Publication No. 2003/0104969 A1, U.S. Pat. No. 6,194,362; U.S. Pat. No. 6,143,707; U.S. Pat. No. 6,491,728; U.S. Pat. No. 5,378,468; U.S. Pat. No. 5,626,852; U.S. Pat. No. 5,710,122; U.S. Pat. No. 5,716,918; U.S. Pat. No. 5,721,202; U.S. Pat. No. 5,744,435; U.S. Pat. No. 5,756,827; U.S. Pat. No. 5,830,835; U.S. Pat. No. 5,919,752; WO 00/02986 published Jan. 20, 2000; and WO 01/04248 published Jan. 18, 2001.

Perfumes, when present, specifically comprise from about 0.001% to about 10%, by weight, more specifically from 0.1% to about 3%, of the compositions herein.

(iii) Water—The compact detergent compositions according to the present invention also contain water. The amount of the water present in the compositions herein will be relatively small, relative to traditional fluid laundry detergent compositions, suitably from about 1 wt % to about 30 wt %, specifically from about 5% to about 25%, by weight of the cleaning composition.

In one embodiment, the water to be used is selected from distilled, deionized, filtered, reverse osmosis treated, and combinations thereof. In another optional embodiment of the water may be any potable water, e.g., as received from a city water treatment works.

(iv) Non-Aminofunctional Solvent—As used herein, “non-aminofunctional solvent” refers to any solvent which contains no amino functional groups. Non-aminofunctional solvent include, for example: C₁-C₅ alkanols such as methanol, ethanol and/or propanol and/or 1-ethoxypentanol; C₂-C₆ diols; C₃-C₈ alkylene glycols; C₃-C₈ alkylene glycol mono lower alkyl ethers; glycol dialkyl ether; lower molecular weight polyethylene glycols; C₃-C₉ triols such as glycerol; and mixtures thereof. More specifically, non-aminofunctional solvents are liquids at ambient temperature and pressure (i.e. 21° C. and 1 atmosphere), and comprise carbon, hydrogen and oxygen. When present, non-aminofunctional solvent may comprise from about 0% to about 10%, specifically from about 0% to about 7%, more specifically from about 2% to about 5%, by weight of the composition, herein.

In one embodiment, the sum of water and non-aminofunctional solvent, by weight of the composition, is from 5% to 45%, specifically 10% to 30%, by weight of the composition, specifically no more than about 40%, more specifically no more than 35%, even more specifically no more than 30%, even more specifically still no more than 25%, by weight of the composition, and specifically having from about 0% to no more than about 10%, more specifically no more than about 7%, even more specifically from about 2% to about 5%, by weight of the composition, of the non-aminofunctional solvent.

Viscosity—In one embodiment, the compositions and methods herein have a neat viscosity, Vₙ, of from about 1,000 cps (or equivalently, millipascal seconds mPas) to about 10,000 cps as measured at 20 s⁻¹, specifically from about 2,000 cps to about 5,000 cps as measured at 20 s¹ and a diluted viscosity, V_{d}, that is less than or equal to about 0.5Vₙ, as measured at 20 s⁻¹, specifically less than about 0.3Vₙ, as measured at 20 s⁻¹. As used herein, “neat viscosity, Vₙ” refers to the viscosity of the undiluted compact fluid laundry detergent. As used herein, “diluted viscosity, V_{d}” refers to the viscosity of a 50% by weight aqueous solution of a compact fluid laundry detergent of the present invention, or a liquid laundry detergent composition prepared and/or used in the methods of the present invention. In another more specific embodiment, when the compact fluid detergent composition is shear thinning, the composition may be characterized by a low-shear neat viscosity Vₗₛ of from about 10,000 cps to about 500,000 cps as measured at 0.5 s⁻¹, more specifically from about 10,000 cps to about 100,000 cps as measured at 0.5 s⁻¹.

The water used to prepare the aqueous solution for determining the diluted viscosity, V_{d} of a composition is deionized water.

The dilution procedure and the viscosity measurements are described in the examples hereinafter.

Aesthetics—The compact fluid laundry detergent composition and the water insoluble container may have any desired appearance or aesthetics. The compact fluid laundry detergent composition water and the insoluble container may be opaque, transparent or translucent, of any color or appearance, such as a pearlescent liquid. In one embodiment, the compact fluid laundry detergent composition may contain air or gas bubbles, suspended liquid droplets, simple or multiple emulsion droplets, suspended particles and the like and combinations thereof. Suitable sizes include from about 0.1 microns to about 5 mm, more specifically from about 20 microns to about 1 mm. These optional suspended liquids and/or particles may be visible as discrete entities, i.e. different color, shape, texture, and the like and combinations thereof. These suspended liquids and/or particles may be a different color, texture or some other visually distinguishing feature than the other portions of the compact fluid laundry detergent composition.

Additionally, the water insoluble container and the compact fluid laundry detergent composition may be any color or combination of colors. It is also to be understood that the term “color” not only includes all the colors of the visible spectrum, namely, red, orange, yellow, green, blue, teal, brown, purple, lilac, sea green, tan, navy, violet, pink and the like, it also includes all shades, tones, hues and the like, such as dark blue, light, blue, light green, etc, of these colors, as well as black, white, and grey and all shades, tones, hues and the like of these. Furthermore, the water insoluble container and the compact fluid laundry detergent composition may also in addition have any additional visual treatments, such as for example, a combination of varied refractive indices, pearlescence, opalescence, reflective, holographic effect, metallic color, gloss finish, matte finish and the like and combinations thereof.

In another embodiment, the compact fluid laundry detergent composition may comprise two or more visually distinctive regions. Each region can itself comprise one or more distinct physical phases. The term “visually distinctive” as used herein describes compositions in the water insoluble container or upon being dispensed that display visually different regions. These different regions are either distinctively separate or partially mixed as long as the compact fluid laundry detergent composition remains visible to the naked eye. The combination of these visually distinctive regions can be chosen to produce any of a wide variety of patterns, including for example: striped, marbled, rectilinear, interrupted striped, check, mottled, veined, clustered, speckled, geometric, spotted, ribbons, helical, swirl, arrayed, variegated, textured, grooved, ridged, waved, sinusoidal, spiral, twisted, curved, cycle, streaks, striated, contoured, anisotropic, laced, weave or woven, basket weave, spotted, and tessellated. The pattern may be striped and may be relatively uniform and even across the dimension any container. Alternatively, the striped pattern may be uneven, i.e. wavy, or may be non-uniform in dimension. The striped pattern does not need to necessarily extend across the entire dimension of any container.

The term “stripe” as used herein means that each phase present in the compact fluid laundry detergent composition occupies separate but distinct physical spaces inside the water insoluble container in which it is stored, but are in direct contact with one another. (i.e. they are not separated by a barrier and they are not emulsified or mixed to any significant degree). The stripes may be relatively uniform and even across the dimension of the water insoluble container. Alternatively the stripes may be uneven, i.e. wavy, or may be non-uniform in dimension. The stripes do not necessarily extend across the entire dimension of the water insoluble container. The “stripe’ can comprise various geometric patterns, various colors and, or glitter or pearlescence, providing that the concentration of these forms visually distinct bands or regions.

The term “marbling” as used herein refers to a striped design with a veined and/or mottled appearance similar to marble.

While many variations in the physical characteristics of the components are possible, i.e., color, viscosity, rheology, texture, density etc, variations in color are widely sought. The specific design or pattern achieved (i.e., width, length of stripe or marbling etc.) in the compact fluid laundry detergent composition can be varied by varying a number of factors for example, rheological characteristics of the phases, diameter of the dispensing means, presence or absence of rotation of the container during filling, rate of speed and constancy and the like and combinations thereof.

Lyotropic liquid crystalline mesophases—Without intending to be limited by theory, the compact fluid laundry detergents herein can include, or not include, by way of physical mesostructure, any of the well-known lyotropic liquid crystalline mesophases, for example as described in “Handbook of Applied Surface and Colloid Chemistry”, Ed. K. Holmberg, ISBN 0471 490830, published by John Wiley and Sons, New York, N.Y., 2001, incorporated herein by reference in its entirety. See especially Chapter 16, “Identification of Lyotropic Crystalline Mesophases”, by Stephen T. Hyde.

Specific embodiments of compact fluid laundry detergents herein include L-alpha phases otherwise known as lamellar mesophases, L-beta phases otherwise known as gel mesophases, and mixtures thereof. Further specific embodiments are characterized by the presence of lamellar mesophases having no detectable gel phase, or by lamellar mesophases free from maltese cross textures in the optical microscope. In other specific embodiments, maltese cross textures may appear after applying shear to the compositions. In certain typical embodiments, no folding into vesicles or spherical globules is observed. In general, as will be noted from the recital of specific surfactants or amphiphiles herein, the present compositions rely principally on single-chain surfactants, amphiphiles or detergents, although the mesostructure may be modified by the inclusion of limited proportions of double-tailed surfactants. Moreover, specific embodiments herein are characterized by the presence of a topological defect-rich lamellar mesophase with relatively low degree of folding. See the above identified reference at page 308, Section 2.1.3, Lamellar mesophases, and subsequent discussion in the same chapter of defect structure.

Adjuncts—The compact detergent composition and methods of the present invention may comprise one or more adjuncts to give it additional desired properties, of functional and/or aesthetic nature.

Hydrotropes—In one embodiment, the adjunct comprises a hydrotrope. Hydrotrope reduces liquid crystal formation. Illustrative hydrotropes include urea, toluene sulphonate, xylene sulphonate, cumene sulphonate and mixtures thereof. Illustrative salts include sodium, potassium, ammonium, monoethanolamine, triethanolamine and mixtures thereof. In one embodiment, the hydrotrope is selected from xylene sulfonate, urea and combinations thereof. In one embodiment, the amount of the optional hydrotrope may be in the range of from about 0 to about 10%, more specifically from about 0 to 5%, even more specifically from about 0 to about 2%, even more specifically still from about 0 to about 1%.

Organic External Structurant—Surprisingly it has been found that compact fluid laundry detergents herein do not require an organic external structurant. Preferred embodiments of the invention are substantially free from organic external structurant. If desired, organic external structurants can be incorporated, for example to adjust the rheology of specific aesthetic embodiments. Such structurants, if used, will comprise from about 0.01% to about 1% by weight, more specifically from about 0.015% to about 0.75% by weight, even more specifically from about 0.02% to about 0.5% by weight of the compositions herein.

An “external” structurant as defined herein is a material which has as its primary function that of providing rheological alteration, typically to increase viscosity of a fluid such as a liquid or gel or paste. External structurants suitable herein do not, in and of themselves, provide any significant fabric cleaning or fabric care benefit. An external structurant is thus distinct from an “internal” structurant which, while it can also alter matrix rheology, has been incorporated into the liquid product for some additional primary purpose. Thus, for example, an internal structurant can be an anionic surfactant which can serve to alter rheological properties of liquid detergents, but which have been added to the product primarily to act as types of cleaning ingredients.

One type of external structuring agent useful in the compositions of the present invention comprises non-polymeric (discounting alkoxylation which may be included), crystalline hydroxy-functional materials which can form thread-like structuring systems throughout the liquid matrix when they are crystallized within the matrix in situ. Such materials can be generally characterized as crystalline, hydroxyl-containing fatty acids, fatty esters or fatty waxes. Such materials will generally be selected from those having the following formulas: 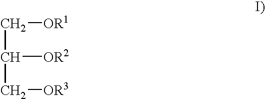
wherein: 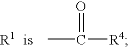
R² is R¹ or H; R³ is R¹ or H; R⁴ is independently C₁₀-C₂₂ alkyl or alkenyl comprising at least one hydroxyl group; 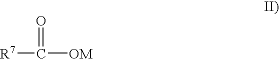
wherein: 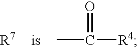
R⁴ is as defined above in i); M is Na⁺, K⁺, Mg⁺⁺ or Al³⁺, or H; and
III) Z-(CH(OH))a-Z′ wherein: a is from 2 to 4, specifically 2; Z and Z′ are hydrophobic groups, especially selected from C₆-C₂₀ alkyl or cycloalkyl, C₆-C₂₄ alkaryl or aralkyl, C₆-C₂₀ aryl or mixtures thereof. Optionally Z can contain one or more nonpolar oxygen atoms as in ethers or esters.

Materials of the Formula I type are preferred. They can be more particularly defined by the following formula: 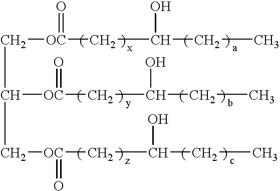
wherein: (x+a) is from between 11 and 17; (y+b) is from between 11 and 17; and (z+c) is from between 11 and 17. Specifically, in this formula x=y=z=10 and/or a=b=c=5.

Specific examples of preferred crystalline, hydroxyl-containing structurants include castor oil and its derivatives. Especially preferred are hydrogenated castor oil derivatives such as hydrogenated castor oil and hydrogenated castor wax. Commercially available, castor oil-based, crystalline, hydroxyl-containing structurants include THIXCIN™ from Rheox, Inc. (now Elementis).

Alternative commercially available materials that are suitable for use as crystalline, hydroxyl-containing structurants are those of Formula III hereinbefore. An example of a structurant of this type is 1,4-di-O-benzyl-D-threitol in the R,R, and S,S forms and any mixtures, optically active or not.

All of these crystalline, hydroxyl-containing structurants as hereinbefore described are believed to function by forming thread-like structuring systems when they are crystallized in situ within the aqueous liquid matrix of the compositions herein or within a pre-mix which is used to form such an aqueous liquid matrix. Such crystallization is brought about by heating an aqueous mixture of these materials to a temperature above the melting point of the structurant, followed by cooling of the mixture to room temperature while maintaining the liquid under agitation.

Under certain conditions, the crystalline, hydroxyl-containing structurants will, upon cooling, form the thread-like structuring system within the aqueous liquid matrix. This thread-like system can comprise a fibrous or entangled thread-like network. Non-fibrous particles in the form of “rosettes” may also be formed. The particles in this network can have an aspect ratio of from about 1.5:1 to about 200:1, more specifically from about 10:1 to about 200:1. Such fibers and non-fibrous particles can have a minor dimension which ranges from about 1 micron to about 100 microns, more specifically from about 5 microns to about 15 microns.

Illustrative exemplary crystalline, hydroxyl-containing structurants, and their incorporation into aqueous shear-thinning matrices, are described in greater detail in U.S. Pat. No. 6,080,708 and in PCT Publication No. WO 02/40627.

Other types of organic external structurants, besides the non-polymeric, crystalline, hydroxyl-containing structurants described hereinbefore, may be utilized in the liquid detergent compositions herein. For example suitable polymeric structurants include those of the polyacrylate, polysaccharide or polysaccharide derivative type. Polysaccharide derivatives typically used as structurants comprise polymeric gum materials. Such gums include pectine, alginate, arabinogalactan (gum Arabic), carrageenan, gellan gum, xanthan gum and guar gum.

If polymeric structurants are employed herein, a preferred material of this type is gellan gum. Gellan gum is a heteropolysaccharide prepared by fermentation of Pseudomonaselodea ATCC 31461. Gellan gum is commercially marketed by CP Kelco U.S., Inc. under the KELCOGEL tradename. Processes for preparing gellan gum are described in U.S. Pat. Nos. 4,326,052; 4,326,053; 4,377,636 and 4,385,123.

Of course, any other structurants besides the foregoing specifically described materials can be employed. Examples of such structurants further include “organogellants” or “organogelators”.

Boric acid derivatives and/or pH jump systems—One specific optional adjunct ingredient may be a boric acid derivative, the use of which is known e.g., for enzyme stabilization. Combinations of borates and polyols, especially sorbitol, constitute pH jump systems which are also known in the art, e.g., U.S. Pat. No. 5,089,163 and 4,959,179 to Aronson et al. The inclusion of pH jump systems herein is not preferred. In another embodiment, the compact fluid laundry detergent is substantially free of pH jump systems, such as, the aforementioned borax sorbitol pH jump system or the like.

In an optional embodiment, the compositions and methods described herein, may comprise less than about 3%, by weight of the detergent composition, more specifically less than about 1%, by weight of the detergent composition, even more specifically is substantially free of boric acid derivatives.

By “boric acid derivatives” it is meant boron containing compounds such as boric acid per se, substituted boric acids and other boric acid derivatives that at least a part of which are present in solution as boric acid or a chemical equivalent thereof, such as a substituted boric acid. Illustrative examples of boric acid derivatives includes boric acid, boric oxide, borax, alkali metal borates (such as sodium ortho-, meta- and pyroborate and sodium pentaborate), and mixtures thereof.

As noted herein, these boric acid derivatives have in the past been used in combination with organic polyol solvents, such as sorbitol, as a pH jump system. The present compact fluid laundry detergent compositions means that the need for a pH jump system, and consequently the use of these boric acid derivatives can be reduced, thereby saving money and time.

Neutralizers—In one embodiment, the adjunct may be a neutralizer. The neutralizers may be acidic or alkali in character depending upon what they will be neutralizing. Illustrative suitable neutralizers include, alkali metal hydroxides, such as NaOH, LiOH, KOH etc; alkaline earth hydroxides, such as Mg(OH)2, Ca(OH)2; ammonium or substituted ammonium hydroxides; alkanolamines, such as, mono-, di- and triethanolamines for example monoethanolamine (MEA); inorganic acids such as, sulfuric acid, hydrochloric acid, nitric acid; organic acids, such as acetic acids, citric acid, lactic acid and the like, and combinations thereof.

These neutralizers may be optionally present in any composition or method specifically from about 0.0001% to about 75%, more specifically from about 0.001% to about 30%, by weight of the compact detergent composition.

Colorants—In one embodiment, the compact fluid laundry detergent composition comprises a colorant, more specifically a colorant in at least one visually distinctive region of the compact fluid laundry detergent composition. The composition comprises from about 0.00001% to about 10%, by weight of the composition of a colorant. More specifically, the compact fluid laundry detergent composition compositions comprises from about 0.0001% to about 1%, even more specifically from about 0.001% to about 0.1%, even more specifically still from about 0.005% to about 0.05%, by weight of the composition of a colorant.

The colorant, in a one specific embodiment, comprises metal ions. More specifically, the colorant is free of barium and aluminum ions which allows for improved lamellar phase stability. The colorant more specifically maintains UV stability.

Colorants suitable for use in the compact fluid laundry detergent composition may be selected from organic pigments, inorganic pigments, interference pigments, lakes, natural colorants, pearlescent agents, dyes, carmines, and mixtures thereof. Dyes which are not destroyed by UV light may also be used if desired.

Non-limiting examples of colorants include: D&C Red 30 Talc Lake, D&C Red 7 Calcium Lake, D&C Red 34 Calcium Lake, Mica/Titanium Dioxide/Carmine Pigments (Clorisonne Red commercially available from Engelhard, Duocrome RB commercially available from Engelhard, Magenta commercially available from Rona, Dichrona RB commercially available from Rona), Red 30 Low Iron, D&C Red Lake Blend of Lake 27 & Lake 30, FD&C Yellow 5 Lake, Kowet Titanium Dioxide, Yellow Iron Oxide, D&C Red 30 Lake, D&C Red 28 Lake, Cos Red Oxide BC, Cos Iron Oxide Red BC, Cos Iron oxide Black BC, Cos Iron Oxide Yellow, Cos Iron Oxide Brown, Cos Iron Oxide Yellow BC, Euroxide Red Unsteril, Euroxide Black Unsteril, Euroxide Yellow Steril, Euroxide Black Steril, Euroxide Red, Euroxide Black, Hydrophobic Euroxide Black, Hydrophobic Euroxide Yellow, Hydrophobic Euroxide Red, D&C Yellow 6 Lake, D&C Yellow 5 Zr Lake, Hidacid blue commercially available from Hilton Davis; Acid blue 145 commercially available from Crompton Knowles and Tri-Con; Pigment Green No. 7, FD&C Green No. 7, Acid Blue 80, Acid Violet 48, and Acid Yellow 17 commercially available from Sandoz Corp.; D&C Yellow No. 10 commercially available from Warner Jenkinson Corp. and mixtures of these colorants.

Non limiting examples of hueing dyes useful herein include Basic Violet 3 (Cl 42555) and Basic Violet 4 (Cl 42600), both commercially available from Standard Dyes.

In one embodiment, the composition compromises a nonstaining dye and a dye color fidelity stabilizer, even more specifically the dye color fidelity stabilizer is a reducing agent, even more specifically sodium bisulfite. As used herein, “nonstaining dye” refers to any dye added for purely aesthetic purposes to the compact fluid laundry detergent and wherein such dye produces no permanent marks on white cotton which is brought directly into contact with an undiluted form of the compact fluid laundry detergent composition. This ensures that the compact fluid laundry detergent composition can be used for direct pretreatment of soiled fabrics, that is, the compact fluid laundry detergent composition can be used as a laundry pretreater.

In another embodiment, the compact fluid laundry detergent composition is substantially free of any dyes. This compact fluid laundry detergent composition can also be used for direct pretreatment of soiled fabrics, that is, the compact fluid laundry detergent composition can be used as a laundry pretreater.

Other Adjuncts—In one embodiment of the instant invention, the adjunct ingredient may be selected from builders, brightener, dye transfer inhibitor, chelants, polyacrylate polymers, dispersing agents, colorant dye, hueing dyes, perfumes, processing aids, bleaching additives, bleach activators, bleach precursors, bleach catalysts, solvents, co-solvents, hydrotropes, liquid carrier, phase stabilizers, soil release polymers, enzyme stabilizers, enzymes, soil suspending agents, anti-redeposition agents, deflocculating polymers, bactericides, fungicides, UV absorbers, anti-yellowing agents, anti-oxidants, optical brighteners, suds suppressors, opacifiers, suds boosters, anticorrosion agents, radical scavengers, chlorine scavengers, structurants, fabric softening additives, other fabric care benefit agents, pH adjusting agents, fluorescent whitening agents, smectite clays, structuring agents, preservatives, thickeners, coloring agents, fabric softening additives, rheology modifiers, fillers, germicides and mixtures thereof. Further examples of suitable adjunct ingredient and levels of use are described in U.S. Pat. No. 3,936,537, issued Feb. 3, 1976 to Baskerville, Jr. et al.; U.S. Pat. No. 4,285,841, Barrat et al., issued Aug. 25, 1981; U.S. Pat. No. 4,844,824 Mermelstein et al., issued Jul. 4, 1989; U.S. Pat. No. 4,663,071, Bush et al.; U.S. Pat. No. 4,909,953, Sadlowski, et al. issued Mar. 20, 1990; U.S. Pat. No. 3,933,672, issued Jan. 20, 1976 to Bartoletta et al.; U.S. Pat. No. 4,136,045, issued Jan. 23, 1979 to Gault et al; U.S. Pat. No. 2,379,942; U.S. Pat. No. 3,308,067; U.S. Pat. No. 5,147,576 to Montague et al; British Pat. No. 1,470,250; British Patent No. 401,413 to Marriott; British Patent No. 461,221 to Marriott and Guam British Patent No. 1,429,143; and U.S. Pat. No. 4,762,645, Tucker et al, issued Aug. 9, 1988.)

Nonlimiting examples of some of possible adjuncts follows.

Embodiments of compact fluid laundry detergents herein include chelants. Chelants are distinguished from common builders such as citrate in that they preferentially bind transition metals. Suitable levels of chelants in the compact fluid laundry detergents are from 0% to about 5%, more specifically from about 0.5% to about 3%, more specifically still from about 1% to about 2%.

Non-limiting examples of suitable chelants include, S,S-ethylenediamine disuccinic acid (EDDS), Tiron® (otherwise know as Catechol-2,5-disulfonate as the acid or water soluble salt), ethylenediamine tetraacetic acid (EDTA), Diethylenetriaminepentaacetate (DTPA), 1-Hydroxyethylidene 1,1 diphosphonic acid (HEDP), Diethylenetriamine-penta-methylene phosphonic acid (DTPMP), dipicolinic acid and salts and/or acids thereof and mixtures thereof. Further examples of suitable chelating agents and levels of use are described in U.S. Pat. Nos. 3,812,044; 4,704,233; 5,292,446; 5,445,747; 5,531,915; 5,545,352; 5,576,282; 5,641,739; 5,703,031; 5,705,464; 5,710,115; 5,710,115; 5,712,242; 5,721,205; 5,728,671; 5,747,440; 5,780,419; 5,879,409; 5,929,010; 5,929,018; 5,958,866; 5,965,514; 5,972,038; 6,172,021; and 6,503,876.

Other chelants useful herein are the water-soluble polyphosphonates, including specifically sodium, potassium and lithium salts of methylene diphosphonic acid; sodium, potassium and lithium salts of ethylene diphosphonic acid; and sodium, potassium and lithium salts of ethane-I,I,2-triphosphonic acid. Other examples include the alkali metal salts of ethane-2-carboxy-I, I-diphosphonic acid hydroxymethanediphosphonic acid, carboxyldiphosphonic acid, ethane-1-hydroxy-I,I,2-triphosphonic acid, ethane-2-hydroxy-1,I,2-triphosphonic acid, propane-1,1,3,3-tetraphosphonic acid, propane-1,1,2,3-tetraphosphonic acid, and propane-1,2,2,3-tetra-phosphonic acid.

Embodiments of compact fluid laundry detergents herein include common builders such as citrate, polycarboxylates, carboxymethyloxysuccinates, oxydisuccinates, tatrtate monosuccinates, tartrate disuccinates and mixtures thereof. Suitable levels of builders in the compact fluid laundry detergents are from 0% to about 20%, more specifically from about 0.5% to about 10%, more specifically still from about 1% to about 8%. One embodiment, of compact fluid laundry detergents herein comprises less than about 5% of builders and includes one or more chelants.

Other examples of suitable builders are water-soluble alkali metal phosphates, polyphosphates, silicates, and carbonates. Specific examples of such salts are sodium and potassium triphosphates, pyrophosphates, orthophosphates, hexametaphosphates, tetraborates, silicates, and carbonates.

Other examples of suitable builders are: water-soluble salts of polycarboxylates polymers and copolymers as described in U.S. Pat. No. 3,308,067; In addition, other polycarboxylate builders can be used satisfactorily, including water-soluble salts of citric acid, and carboxymethyloxysuccinic acid, salts of polymers of itaconic acid and maleic acid, tartrate monosuccinate, tartrate disuccinate and mixtures thereof (TMS/TDS).

Enzymes which may be used in this invention are described in greater detail below. In one embodiment, the optional enzyme when present may be selected from protease, cutinase, hemicellulase, peroxidases, cellulases, xylanases, lipases, phospholipases, esterases, cutinases, pectinases, keratanases, reductases, oxidases, phenoloxidases, lipoxygenases, ligninases, pullulanases, tannases, pentosanases, malanases, β-glucanases, arabinosidases, hyaluronidase, chondroitinase, lactase, amylase and mixtures thereof.

A non-limiting list of suitable commercially available enzymes include: Amylases (α and/or β) are described in WO 94/02597 and WO 96/23873. Commercial examples are Purafect Ox Am® [Genencor] and Termamyl®, Natalase®, Ban®, Fungamyl® and Duramyl® [all ex Novozymes]. Cellulases include bacterial or fungal cellulases, e.g. produced by Humicola insolens, particularly DSM 1800, e.g. 50 Kda and ^{˜}43 kD [Carezyme®]. Also suitable cellulases are the EGIII cellulases from Trichoderma longibrachiatum. Suitable lipases include those produced by Pseudomonas and Chromobacter groups. Preferred are e.g. Lipolase®, Lipolase Ultra®, Lipoprime® and Lipex® from Novozymes. Also suitable are cutinases [EC 3.1.1.50] and esterases. Carbohydrases e.g. mannanase (U.S. Pat. No. 6,060,299), pectate lyase (WO99/27083) cyclomaltodextringlucanotransferase (WO96/33267) xyloglucanase (WO99/02663). Bleaching enzymes eventually with enhancers include e.g. peroxidases, laccases, oxygenases, (e.g. catechol 1,2 dioxygenase, lipoxygenase (WO 95/26393), (non-heme) haloperoxidases. Suitable commercially available proteases, include, Alcalase®, Savinase®, Kannase®, Everlase®, Esperase® commercially available from Novozymes; Purafect®, Purafext Ox®, Properase® commercially available from Genencor; BLAP and BLAP variants commercially available from Henkel; Maxatase and Maxacal of commercially available from Gist-Brocades; Kazusase of Showa Denko; and K-16-like proteases commercially available from KAO. Additional illustrative proteases are described in e.g. EP130756, WO91/06637, WO95/10591, WO99/20726, U.S. Pat. No. 5,030,378 (Protease “A”) and EP251446 (Protease “B”).

Exemplary bleaching additives includes bleaches such as hydrogen peroxide, perborate, percarbonate or peroxyacids such as 6-phthalimidoperoxyhexanoic acid and mixtures thereof. The present articles include embodiments which are substantially free from bleach.

There also may be included in the formulation, minor amounts of soil suspending or anti-redeposition agents, e.g. sodium carboxymethyl cellulose or hydroxy-propyl methyl cellulose.

Soil releasing agents, e.g. derivatives of polyesters can be used herein, as can deflocculating polymers such as those found in U.S. Pat. No. 5,147,576 to Montague et al.

Anti-foam agents, e.g. silicone compounds, such as Silicane L 7604, can also be added to the compositions.

One specific optional adjunct ingredient may be a pH jump system (e.g., boron compound/polyol), as described in the U.S. Pat. Nos. 5,089,163 and 4,959,179 to Aronson et al. The inclusion of the pH jump system ensures that the pH jumps up in the washing machine to neutralize fatty acid to the soap form, so as to obtain the benefits of neutralized fatty acid and to minimize surfactant amount. In another embodiment, the compact fluid laundry detergent is substantially free of pH jump systems, such as, the aforementioned borax sorbitol pH jump system or the like.

These adjuncts may be optionally present in any composition or method of the present invention from about 0.0001% to about 95%, specifically from about 0.001% to about 70%, by weight of the compact detergent composition.

The list of adjuncts herein is not intended to be exhaustive and other unlisted adjuncts well known in the art, may also be included in the composition.

Water Insoluble Container—In one embodiment, the compact fluid laundry detergent may be releasably stored in a water insoluble container. As used herein “water insoluble container” refers to a container that does not lose its shape, typically its capability to be in direct contact with the compact fluid laundry detergent and releasably store the compact fluid laundry detergent, while any compact fluid laundry detergent remains in the water insoluble container. Specifically, this means that the water insoluble material comprises a material which is insoluble in water.

The water insoluble container may be made of any suitable material such as, glass, metal, polymer and the like and combinations thereof. In one embodiment, the water insoluble container comprises a polymeric material, although other packages such as paperboard cartons with film lining and glass bottles may be used. In one embodiment, the water insoluble container, is a polymeric material selected from polypropylene (PP), polyethylene (PE), polycarbonate (PC), polyamides (PA) polyethylene terephthalate (PET), polyvinylchloride (PVC), polystyrene (PS), and combinations thereof.

In one embodiment, the water insoluble container may be at least partially, more specifically totally transparent or translucent. In another embodiment, the water insoluble container may be at least partially, more specifically totally opaque. In another embodiment, the water insoluble container is substantially opaque and contains a transparent or translucent portion or window which is capable of providing information on how much compact fluid laundry detergent composition is present in the water insoluble container. This transparent or translucent portion or window may be of any suitable size or shape as long as it provides enough information on how much compact fluid laundry detergent composition is present in the water insoluble container. In another embodiment, a magnifying window can be placed on the water insoluble container so that the contents are more readily visible.

The water insoluble container of the present invention may be of any form or size suitable for storing and packaging liquids for household use. For example, in one embodiment, the water insoluble container has a capacity of 100 ml to 3000 ml, more specifically 250 ml to 1500 ml. In one embodiment, the water insoluble container is suitable for easy handling, for example the container may have a handle or a part with such dimensions as to allow easy lifting or carrying the container with one hand.

The water insoluble container may be formed by any suitable process, such as, thermoforming, blow molding, injection molding, injection-stretch blow bolding (ISBM) or the like. The water insoluble container may be any size or shape.

In one embodiment, the water insoluble container may be at least partially, more specifically totally transparent or translucent. In another embodiment, the bottom dispensing container may be at least partially, more specifically totally opaque.

In one embodiment, the water insoluble container is selected from top dispensing containers, bottom dispensing containers, side dispending containers, and combinations thereof.

In another embodiment, the water insoluble container has a means suitable for pouring the composition and means for reclosing the water insoluble container. The pouring means may be of any size or form but, preferably will be wide enough for conveniently dosing the composition. The optional closing means may be of any form or size but usually will be screwed on, clicked on, or otherwise attached to the container to close the water insoluble. The optional closing means may be cap which can be detached from the water insoluble container. Alternatively, the optional cap can still be attached to the water insoluble container, whether the water insoluble container is open or closed. The optional closing means may also be incorporated in the water insoluble container.

In one embodiment the water insoluble containers typically include an opening for dispensing the composition there through and actuation means for dispensing the composition. One illustrative type of water insoluble containers is the so called squeeze containers. Squeeze containers are usually formed from a resiliently deformable material and have an opening, more specifically at the top, side and/or bottom of the container that may have a valve to control the flow through the opening.

One type of useful valve is an on-off valve that is actuated by rotating the valve. Another particularly useful valve is a pressure-responsive dispensing valve that controls the flow according to a pressure difference across the valve. Such a valve can be configured to be normally closed and to assume an open configuration when the container is squeezed.

Alternatively, the squeeze containers may be the so called bag in bottle containers or a so called airless bottle container.

Optional features of water insoluble squeeze containers include a cap to prevent loss of the composition between dispensing. Water insoluble containers of rigid materials having pump mechanisms are also suitable for use herein.

In another embodiment, the water insoluble container is capable of preventing olfactory access by a consumer to a head space co-located with the compact fluid laundry detergent composition in the insoluble container during dispensing of the compact fluid laundry detergent. As used herein “preventing olfactory access” refers to the inability of the consumer to have olfactory access, i.e. smell or otherwise detect, the head space of the compact fluid laundry detergent during dispensing. This olfactory access may be prevented by dispensing the compact fluid laundry detergent from a region of the water insoluble container remote from the location of the head space in the container, such as at the bottom, front, and/or side of the container.

In another embodiment, the water insoluble container comprises a deformable container for storing the compact fluid laundry detergent composition and a dispensing cap. The deformable container having a bottom end and an opening in the bottom end, more specifically the opening comprises a slit valve which is adapted for dispensing, liquids, gels and/or pastes. The dispensing cap being removably attached to the bottom end of the deformable container and covering at least the opening in the bottom end. More specifically the dispensing cap further comprises a closable discharge opening that is in fluid communication with the opening in the bottom end.

In another embodiment, the water insoluble container is capable of delivering a variable amount, or dose, of the compact fluid laundry detergent composition. In another embodiment, the water insoluble container is capable of delivering a premeasured amount, or dose, of the compact fluid laundry detergent composition. In another embodiment, premeasured dose is preset by said container so as to provide units of one-half of a recommended dose. As used herein “recommended doses” refers to the amount of compact fluid laundry detergent composition that a consumer should use in any particular usage situation. In another embodiment, the article of commerce has the following recommended doses in function of water hardness and soil level: low soil or soft water dosage is 10 ml to 40 ml; medium soil or medium water hardness water dosage 20 to 50 ml; high soil or high water hardness water dosage 30 to 70 ml.

In another embodiment, the water insoluble container has a capacity of may contain from about 3 to about 50, specifically from about 6 to about 50, recommended doses of the compact fluid laundry detergent composition. In another embodiment, the water insoluble container has a volume of from 250 ml to 1500 ml and a dose capacity of from about 6 to about 50 recommended doses.

In another embodiment, a dispensing device for dispensing a variable dose of compact fluid laundry detergent composition and for laundering fabrics therewith is provided with the water insoluble container. The dispensing device when present is detachably mounted on the water insoluble container. In one embodiment, the dispensing device is the dispensing cap.

In another embodiment, the water insoluble container, more specifically a dispensing or dosing device, such as a dosing ball, has markings to provide fractions of a recommended dose such that a specified numbers of fractions of the recommended dose are to be used for laundering in hard, medium and soft water. These markings facilitate dose compliance on dosing a compact fluid laundry detergent composition for use in a laundry appliance. In another embodiment, the water insoluble container comprises a dispensing device detachably mounted on the water insoluble container and the dispensing device has said markings thereon.

Illustrative examples of suitable water insoluble containers may be found in U.S. Provisional Application Ser. No. 60/541,114, filed Feb. 2, 2004, entitled “CONTAINER HAVING A HELICAL GRIP,” to Brian Floyd,; U.S. Pat. Nos. 4,550,862; and 4,981,239; U.S. Pat. No. 6,705,492, issued on Mar. 16, 2004 to Lowry; U.S. Pat. No. 4,969,581, issued on Nov. 13, 1990 to Seifert et al; U.S. Pat. No. 6,494,346, issued on Dec. 17, 2002 to Gross et al; U.S. Pat. No. 5,626,262, issued on May 6, 1997 to Fitten et al; U.S. Pat. No. 5,655,687, issued on Aug. 12, 1997 to Fitten et al; U.S. Pat. No. 4,728,006, issued on Mar. 1, 1988 to Drobish et al; U.S. Pat. No. 6,269,837, issued on Aug. 7, 2001 to Arent et al; U.S. Pat. No. 4,749,108, issued on Jun. 7, 1988 to Dornsbusch et al; U.S. Pat. No. 6,675,845, issued on Jan. 13, 2004 to Volpenheim et al; U.S. Pat. Nos. 4,732,315; 6,021,926; 6,269,962; 4,846,359; 6,960,375; 6,223,945; 6,902,077; 6,824,001; 6,959,834; 6,491,165; 5,050,742; 6,705,465; 6,630,437; 6,756,350; 6,366,402; 6,159,958; and 6,601,705; WO 92/21569 entitled “Inverted Dispenser”, published Dec. 10, 1992 in the name of Canada Inc; WO 01/04006 entitled “Container”, published Jan. 18, 2001 in the name of Unilever; EP 21,545 published Jan. 7, 1981 in the name of The Procter and Gamble Company; and EP 811,559 published Dec. 10, 1997 in the name of Unilever; and in US. Design Pat. Nos. Des. 403,578; Des. 414,421; Des. 425,792; Des. 491,071; Des. 466,816; Des. 457,064; Des. 439,520; Des. 286,602; Des. 429,643; Des. 472,151; Des. 417,622; Des. 322,748; and Des. 509,748.

Illustrative examples of water insoluble containers, namely bottom dispensing containers, may be found in copending U.S. Provisional Patent Application No ______, entitled “Fabric Treatment Dispensing Package” filed on May 5, 2006 in the name of Ann Dewree, et. al., Attorney Docket Number 10403P.

In one embodiment, the water insoluble container may have indicia in association therewith. As used herein, “indicia” refers to scent, branding, packaging, properties, sound, words, phrases, letters, characters, brand names, company names, company logos or symbols, descriptions, logos, icons, designs, designer names, symbols, motifs, insignias, figures, marks, signals, colors, textures, shapes, tokens, advertisements, and combinations thereof.

As used herein, “in association with” means the indicia, and the like are either directly printed on, or attached thereto the article of commerce, the water insoluble container itself, or a label attached to said article of commerce or parts thereof and/or are presented in a different manner including, a brochure, print advertisement, electronic advertisement, and/or verbal communication, so as to communicate the indicia to a consumer.

In one embodiment, the indicia is selected from words, phrases, brand names, company names, descriptions, perfume names, designer names, advertisements, and combinations thereof. The indicia may be in one or more than one language.

In one embodiment, the indicia in association with the water insoluble container comprises information selected from dispensing information, storage information, fabric information, product information, related product information and combinations thereof.

In another specific optional embodiment, one or more indicia may be printed directly on the water insoluble container, more specifically the deformable container and/or the dispensing cap. In another embodiment, one or more indicia may be embossed on the on the water insoluble container, more specifically the deformable container and/or the dispensing cap.

In one embodiment, the indicia in association with the water insoluble container, more specifically the deformable container and/or the dispensing cap via a label. A label provides a convenient point-of-purchase site for the indicia and the like. The term “label” is used herein in the broadest sense to include the tangible medium that may optional contain one or more indicia, that may be optionally expressed including, by way of illustrative example, the placing of indicia directly onto a container (e.g., printing or molding), the printing of indicia on a substrate wherein the substrate is placed on, or associated therewith, the outside surface of the water insoluble container, more specifically the deformable container and/or the dispensing cap, or packaging such as boxes that enclose the water insoluble container, more specifically the deformable container and/or the dispensing cap. In one embodiment, an olfactory scent descriptor may also be provided via a label (e.g., packaging). For example, the label itself may be scented, i.e., comprises a scent.

The optional labels of the present invention may generally mimic the shape of the water insoluble container, more specifically the deformable container and/or the dispensing cap. Illustrative examples of suitable label include, partially wrap-around labels, wrap-around labels, shrink-wrap labels, stickers, in-mold labels hang-tags, labels conveying the name of the product and combinations thereof.

In one embodiment, the label is a clear substrate such that the indicia may be printed onto the label and the water insoluble container, more specifically the deformable container and/or the dispensing cap (if the water insoluble container more specifically the deformable container and/or the dispensing cap is transparent/translucent) is substantially visible by the consumer through the label where the indicia is absent. Without wishing to be bound by theory, a clear label may maximize the color of the composition or the tint of the water insoluble container in communicating to the consumer.

In another embodiment, the label has a background color to further communicate to the user. For example, if the scents or scent identifiers are magnolia and orange, the label may have an orange background color to further communicate this scent experience to the user given the visual association of an orange color to orange fruit and/or orange blossoms and hence the orange scent.

In another specific optional embodiment, one or more indicia may be printed directly on the water insoluble container, more specifically the deformable container and/or the dispensing cap. In another embodiment, one or more indicia may be embossed on the water insoluble container, more specifically the deformable container and/or the dispensing cap.

In one optional embodiment, the label is “shrink wrapped” on the water insoluble container, more specifically the deformable container and/or the dispensing cap. In another optional embodiment, the label is adhered to the water insoluble container, more specifically the deformable container and/or the dispensing cap by an adhesive.

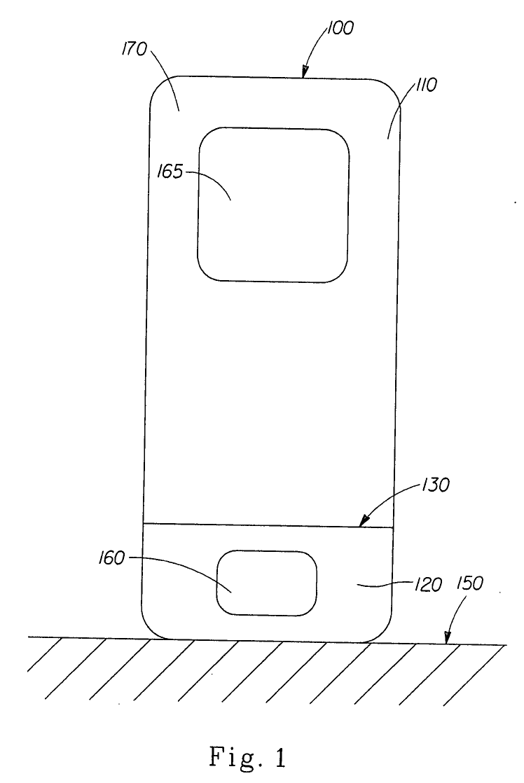

The various different and optional embodiments of the water insoluble container, and/or parts thereof, such as for example the dispensing cap, may be further explained and illustrated with reference to FIGS. 1 to 10.

FIG. 1, is one illustrative example of a water insoluble container 100, comprising a deformable container 110 and a dispensing cap 120 which is removably attached thereto. The deformable container 110 has a bottom end 130 with an opening 140 therein. The dispensing cap 120 is removably attached to the bottom end 130 of the deformable container 110 covering the opening 140. The dispensing cap 120 is also shown resting on the surface 150 in an upright position.

FIG. 1 is an illustrative example of a water insoluble container 100 having indicia 160 and 165 in association therewith. The indicia 160 and 165, which may be the same or different is in association with the deformable container 110 and the dispensing cap 120. In this embodiment, the indicia in association therewith 160 and 165 are two labels which are fastened to the deformable container 110 and the dispensing cap 120 via adhesive.

The deformable container 110 of FIG. 1 also has a top end 170 which is distal to the bottom end 130. The deformable container 110 is also capable of resting on the surface 150 in an upright position with top end 170 contacting the surface 150, that is, now inverted with respect to the deformable container 110 as shown in FIG. 1.

As noted previously any portion of the water insoluble container 100, such as the deformable container 110 and/or the dispensing cap 120 can be translucent or transparent.

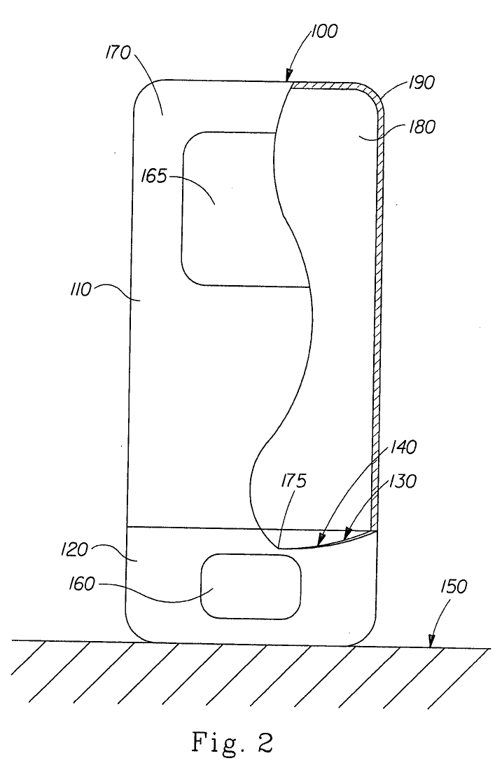

FIG. 2, is a section view of one possible embodiment of the water insoluble container 100 of FIG. 1 along line 2. This section view shows the compact fluid laundry detergent composition 180 and the optional valve 175, through which the compact fluid laundry detergent composition 180 is dispensed. The water insoluble container 100 is also shown in direct contact with and releasably storing the compact fluid laundry detergent composition 180. Also shown is the wall 190 of the deformable container 110.

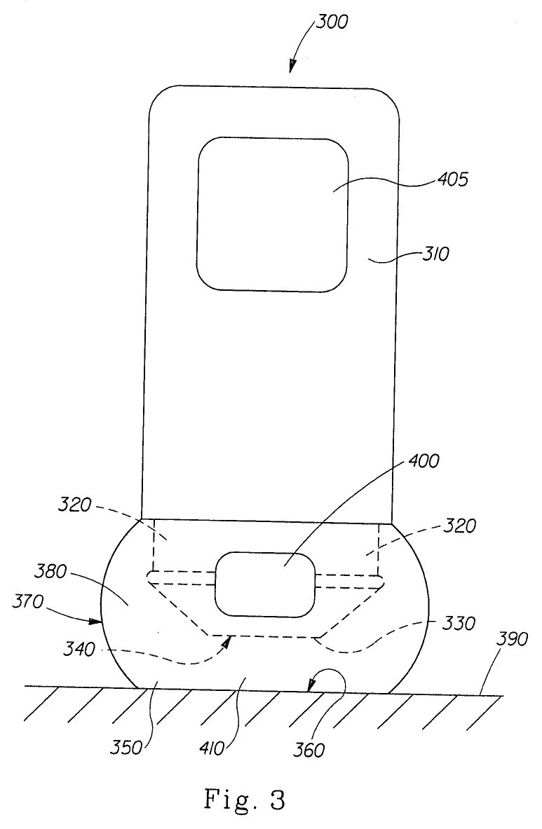

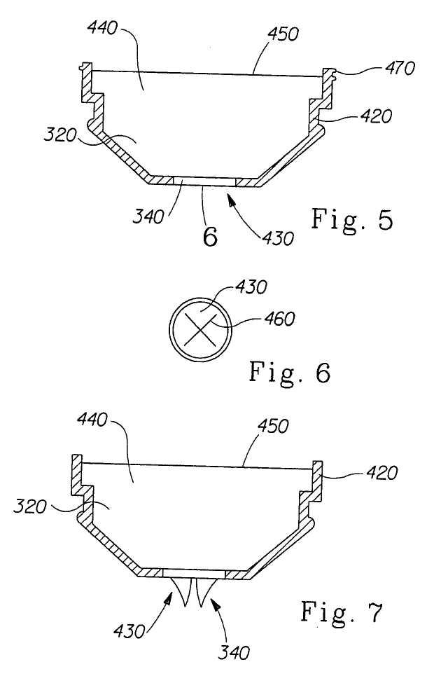

FIG. 3 is another alternative example of a water insoluble container 300, comprising a deformable container 310 and a dispensing cap 350 which is removably attached thereto. The deformable container 310 is attached, e.g. by snap fitting, to a dispensing end 320 having a base 330 for supporting the deformable container 310 in an upright position with a dispensing opening 340 therein. The dispensing cap 350 covers the opening 340 and the valve 430 (FIG. 5). The dispensing cap 350 supports the deformable container 310 in an upright position. The dispensing cap 350 is removably attached to the deformable container 310 over the dispensing opening 340 and covering the valve 430 and opening 340. The dispensing cap 350 is formed of a cup shaped member 410 having a face 360 and a cylindrical wall 370 which extends from the face to define an interior 380 of the dispensing cap 350. The face 360 of the dispensing cap 350 is also shown resting on the surface 390 in an upright position. The dispensing cap 350 is capable of receiving and dispensing compact fluid laundry detergent composition 450 (FIG. 5), more specifically dispensing the compact fluid laundry detergent composition 450 within a washing machine.

The water insoluble container 300 has indicia 400 and 405 in association therewith. The indicia 400 and 405 which may be the same or different is in association with the deformable container 310 and the dispensing cap 350. In this embodiment, the indicia in association therewith 400 and 405 are two labels which are fastened to the deformable container 310 and the dispensing cap 350 via adhesive.

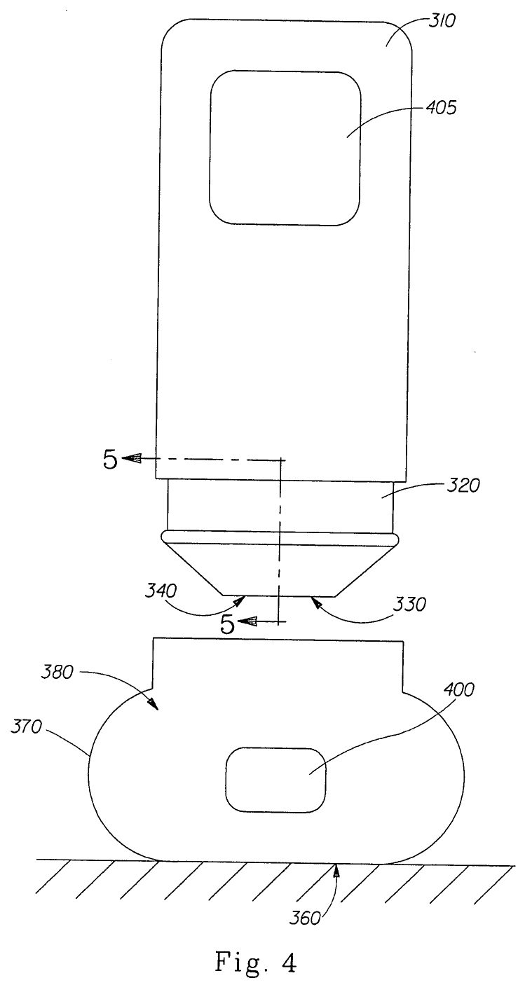

FIG. 4 is an exploded view of the water insoluble container 300 of FIG. 3, which shows the dispensing cap 350 as releasably attached to the deformable container 310.

FIG. 5 is a section view of one possible embodiment of the water insoluble container 300 of FIG. 4 along line 5. This sectional view shows the inner cavity 440 which is for storing the compact fluid laundry detergent composition 450 and the optional valve 430, through which the compact fluid laundry detergent composition 450 is dispensed. Also shown is the wall 420 of the deformable container 310. The valve 430 is shown in the closed position, such that compact fluid laundry detergent composition 450 is prevented from flowing through the dispensing opening 340.

FIG. 6 is a section view of one possible embodiment of the valve 430 of FIG. 5 along line 6. The valve 430 has a small cross slit 460 therethrough.

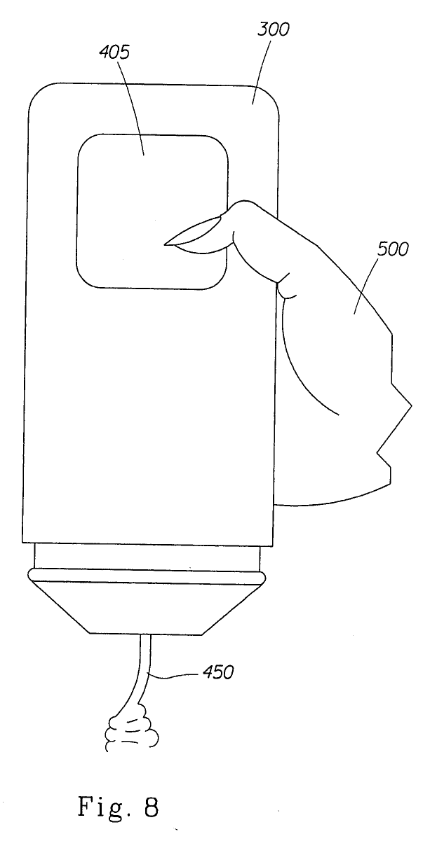

FIG. 7 is a section view of one possible embodiment of the water insoluble container 300 of FIG. 4 along line 5. The valve 430 is shown in the open position, such that compact fluid laundry detergent composition 450 is allowed to flow from the inner cavity 440 and through the dispensing opening 340.

The valve 430 in one specific optional embodiment only allows the compact fluid laundry detergent composition 450 to pass through the dispensing opening 430 when it is subjected to a pressure greater than that of the compact fluid laundry detergent composition 450 under normal gravity.

Alternatively, the valve 430 in another specific optional embodiment is a bimodal valve wherein the bimodal valve has a first mode of operation capable of retaining the compact fluid laundry detergent composition 450 without leakage when the deformable container 310 is subjected to unintentional external forces, such as can be seen illustrated in FIG. 5, and a second mode of operation capable of dispensing the compact fluid laundry detergent composition 450 when the deformable container 310 is subjected to external forces intentionally applied by a user, such as can be seen illustrated in FIG. 7.

FIG. 8 is an illustrative example of the water insoluble container 300 of FIG. 3 being gripped by a human hand 500 and dispensing the compact fluid laundry detergent composition 450. (Note: the human hand or parts thereof, are not part of the scope of the present invention).

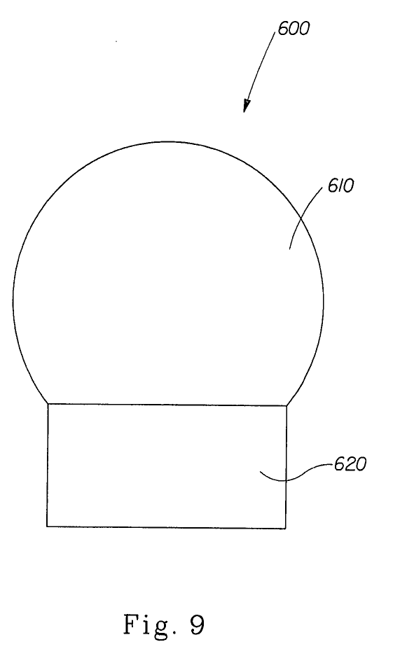

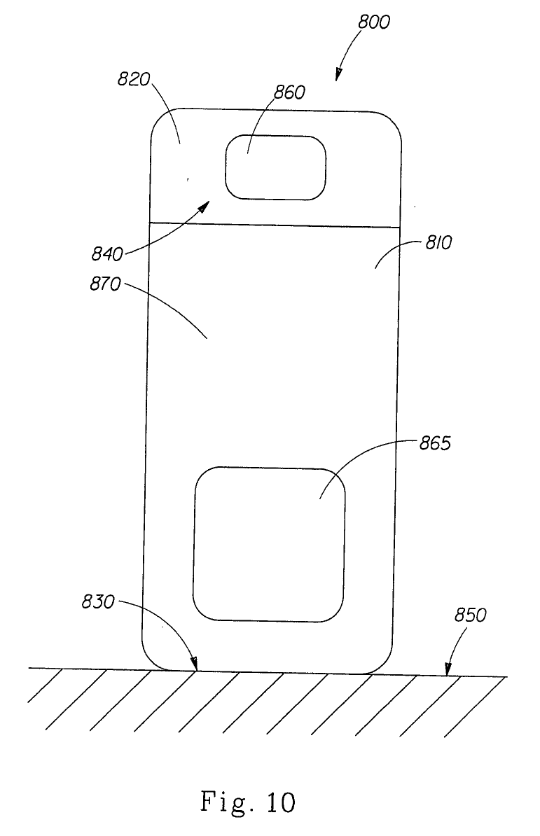

FIG. 9 is an illustrative example of another possible water insoluble container. In FIG. 9, the water insoluble container 700 comprises a side dispensing spherical deformable container 610 and a rectangular dispensing cap 620.

FIG. 10, is another illustrative example of a water insoluble container 800, in this case a top dispensing container comprising a deformable container 810 and a dispensing cap 820 which is removably attached thereto. The deformable container 810 has a top end 870 with an opening 840 therein. The dispensing cap 820 is removably attached to the top end 870 of the deformable container 810 covering the opening 840. The bottom of the deformable container 810 is also shown resting on the surface 850 in an upright position.

FIG. 10 is an illustrative example of a water insoluble container 800 having indicia 860 and 865 in association therewith. The indicia 860 and 865 which may be the same or different is in association with the deformable container 810 and the dispensing cap 820. In this embodiment, the indicia in association therewith 860 and 865 are two labels which are fastened to the deformable container 810 and the dispensing cap 820 via adhesive.

The deformable container 810 of FIG. 10 also has a bottom end 830 which is distal to the top end 870. The deformable container 810 is also capable of resting on the surface 850 in an upright position with bottom end 830 contacting the surface 850.

As noted previously any portion of the water insoluble container 800 such as the deformable container 810 and/or the dispensing cap 820 can be translucent or transparent.

Array of Consumer Products—One optional aspect of the present invention comprises an array of consumer products, specifically comprising at least one of articles of commerce described herein. In one embodiment, each of the articles of commerce present in the array of consumer products would be different in some fashion. This difference may be, for example, the shape of the water insoluble container or parts thereof (such as the deformable container and/or dispensing cap), volume of the water insoluble container or parts thereof, dimension of the water insoluble container or parts thereof, color of the water insoluble container or parts thereof, indicia in association with the water insoluble container or parts thereof, different compact fluid laundry detergent compositions, and the like and combinations thereof.

In one embodiment, the array is an array of laundry products, even more specifically an array of laundry products comprising an indicia in association with the at least two or more articles of commerce, the indicia providing a visual indication of a relationship between the at least two or more articles of commerce.

Transparent or translucent—As used herein, “translucent or transparent” refers to a transmittance of greater than about 25% transmittance of at least one wavelength of electromagnetic radiation in the visible spectrum (approx. 410-800 nm), more specifically a transmittance of more than about 25%, even more specifically more than about 30%, even more specifically still more than about 40%, yet even more specifically still more than about 50% in the visible part of the electromagnetic spectrum wherein % transmittance equals:

$$\frac{1}{{10}^{absorbancy}} \times 100 \% .$$

Alternatively, a container, composition and the like may be considered translucent or transparent if the absorbency of the bottle of the visible electromagnetic spectrum is less than about 0.6. An illustrative example of a translucent or transparent object would be a clear bottle or clear composition. Another example of a translucent or transparent object would be a bottle or composition which is colored, such having a blue or red tint, but still has a transmittance of greater than about 25% transmittance of at least one wavelength of electromagnetic radiation in the visible spectrum.

In one embodiment, the compact fluid laundry detergent composition is transparent or translucent and has a transmittance of at least about a 50% transmittance of light using a 1 cm cuvette at wavelengths of about 410 nanometers to about 800 nanometers.

Additional illustrative information and examples of translucent or transparent and opaque containers and/or compositions and the like can be found in U.S. Pat No. 6,630,437 issued to Murphy et al; U.S. Pat. No. 6,756,350 issued to Giblin et al; U.S. Pat. No. 6,631,783 issued to Giblin et al; and U.S. Pat. No. 6,159,958 issued to Bae-Lee et al.

As used herein, “opaque” refers to a transmittance of less than about 25% transmittance of all wavelengths of electromagnetic radiation in the visible spectrum, more specifically a transmittance of less than about 20%, even more specifically less than about 15%, even more specifically still less than about 10%, yet even more specifically still less than about 5% in the visible part of the electromagnetic spectrum. Alternatively, a container, composition and the like may be considered opaque if the absorbency of the bottle of the visible electromagnetic spectrum is greater than about 0.6.

Methodology—Measurement of Absorbency and Transmittance-Instrument: Milton Roy Spectronic 601.

Procedure:

1. Both the spectrophotometer and the power box were turned on and allowed to warm up for 30 minutes.
2. Set the wavelength: Type in the desired wavelength on the keypad (i.e., 590, 640, etc.). Press the [second function] key. Press the “go to λ” [yes] key. The machine is then ready to read at the chosen wavelength.
3. Zero the instrument: Press the [second function] key. Press the “zero A” [% T/AIC]. 10 Instrument should then read “XXX NM 0.000 A T”
4. Open the cover, place sample vertically and in front of the sensor.
5. Close the lid and record reading (ex. 640 NM 0.123 A T)

Note: All readings are taken in “A” mode (absorbency mode). Zero instrument with every new wavelength change and/or new sample.

Absorbency Values for Two Typical Plastic Bottles

| | Polyethylene (HDPE) | Polypropylene (PP) |
|---|---|---|
| Wavelength (in nm) | 0.960 mm thickness | 0.423 mm thickness |
| 254 (non-visible) | 1.612 | 1.886 |
| 310 (non-visible) | 1.201 | 0.919 |
| 360 (non-visible) | 0.980 | 0.441 |
| 590 (visible) | 0.525 | 0.190 |
| 640 (visible) | 0.477 | 0.169 |

Use of the Composition—The compact fluid laundry detergent may be used as laundry cleaning products. In use, a measured amount of the compact fluid laundry detergent is deposited on the fabric, garment or the like or in the laundry washing machine, whereupon mixing with water, the cleaning of laundry is affected. It should be noted that the compact fluid laundry detergent are particularly suitable for the use in front-loading laundry machines, or so called High Efficiency, or HE washing machines.

Viscosity measurements—The viscosity of fluid detergents herein, namely Vₙ, and V_{d}, is measured using a TA AR550 Rheometer, manufactured by TA Instruments Ltd. Bilton Center, Cleeve Road Letherhead Surrey KT22 7UQ, United Kingdom. The software used is provided with the instrument and called “Rheology Advantage Instrument Control AR”.

The instrument is set up before each measurement according to the instructions reported in the Manual “AR550 Rheometer Instrument and accessory manual” (January 2004, PN500034.001 rev F) p 25-29, 40-44, and the Manual “Rheology advantage Instrument Control Getting Started Guide” (January 2004, Revision E) p 9-14,20,25-28,37-38. The settings and parameters used are described herein.

In the “Geometry” section of the software (see Rheology advantage Instrument Control Getting Started Guide” (January 2004, Revision E) p 9), the gap between the rotating plate (40 mm steel plate) and the sample platform (Peltier plate) is set at 500 microns. The procedure is a continuous ramp test, i.e. a procedure in which the rheology of the sample is measured versus increasing shear rate. The setting for the shear rate ranges from 0.04 s⁻¹ to 30 s⁻¹ with a total duration of 3 minutes for the continuous ramp test, and sampling of 20 points per each tenfold increase in shear rate (automatically done), providing in total 60 measurements. Temperature is set at 21° C.

A sample of compact fluid laundry detergent composition according to the invention, or a sample of a non-inventive laundry detergent for purposes of comparison is loaded into the rehometer using a loading procedure as described herein. The sample loading procedure (as described in detail in the manual) is as follows:
1. The temperature is checked (see “instrument status” section) to see if it matches the set temperature. If the temperature is not correct, the settings need to be verified following the instructions in the manual.
2. The sample is loaded using a plastic pipette with a minimum diameter of 4 mm at the tip (to minimize the impact of the stress carried out by the loading action on the rheology of the sample). A minimum amount of 5 ml needs to be applied in the center of the peltier plate to assure full product coverage of the rotating plate.
3. The rotating plate (plate connected to the measuring system) is brought to the set distance (as defined above).
4. The excess of sample (i.e. any sample that may be around the edges of the rotating plate) is removed with a spatula assuring correct loading of the sample according to the description in the manual.
   The measurement steps are as follows:
5. After the sample is loaded, it needs to be left for 10 seconds at rest. The run is started, while making sure the equipment is not exposed to vibrations during the measurement, as this will effect the results. In the case that the measurement is influenced by vibrations, the experiment is repeated whilst excluding the source of vibration.
6. At the end of the run the program stops automatically. All viscosity data are automatically saved.
7. The plates are cleaned with water and ethanol and then dried with paper towel.
The viscosity data, Vₙ, quoted herein is determined at a shear rate of 20s−1
The data quoted in the patent examples refer to a shear rate of 20s−1. In case no measurement was taken at exactly 20s−1, the data are calculated based on interpolation of the data points which are closest to the 20s−1 point.

Table 1 shows detailed product compositions. The composition 1 is representative of the invention. Compositions A and B are comparative compositions.

TABLE 1
(% by Weight)

| | | Comparative | Comparative |
|---|---|---|---|
| Ingredients | 1 | Example A | Example B |
| Alkylbenzenesulfonic acid | 17.2 | 12.2 | 23 |
| C12-14 alcohol 7-ethoxylate | 8.6 | 0.4 | 19.5 |
| C14-15 alcohol 8-ethoxylate | — | 9.6 | — |
| C12-14 alcohol 3-ethoxylate | 8.6 | — | — |
| sulphate, Na salt | | | |
| C8-10 Alkylamidopropyldimethyl | — | — | 0.9 |
| amine | | | |
| Citric acid | 2.9 | 4.0 | — |
| C12-18 fatty acid | 12.7 | 4.0 | 17.3 |
| Enzymes | 3.5 | 1.1 | 1.4 |
| Ethoxylated polyimine | 1.4 | — | 1.6 |
| Ethoxylated polyimine polymer, | 3.7 | 1.8 | 1.6 |
| quaternized and sulphated | | | |
| Hydroxyethane diphosphonic | 1.4 | — | — |
| acids (HEDP) | | | |
| Pentamethylene triamine | — | 0.3 | — |
| pentaphosphonic acid | | | |
| Catechol 2, 5 disulfonate, | 0.9 | — | — |
| Na salt | | | |
| Fluorescent whitening agent | 0.3 | 0.15 | 0.3 |
| 1,2 propandiol | 3.5 | 3.3 | 22 |
| Ethanol | — | 1.4 | — |
| Diethylene glycol | — | 1.6 | — |
| 1-ethoxypentanol | 0.9 | — | — |
| Sodium cumene sulfonate | | 0.5 | — |
| Monoethanolamine (MEA) | 10.2 | 0.8 | 8.0 |
| MEA borate | 0.5 | 2.4 | — |
| Sodium hydroxide | — | 4.6 | — |
| Perfume | 1.6 | 0.7 | 1.5 |
| Water | 22.1 | 50.8 | 2.9 |
| Perfume, dyes, miscellaneous | Balance | Balance | Balance |
| minors | | | |

The viscosity Vn of the composition 1 and the reference compositions A and B are measured according to the protocol reported above.

Then the compositions are diluted with water according to the following protocol. 100 grams of composition are weighted in a plastic beaker. The beaker is stirred with a mechanical stirrer rotating at low speed 200 rpm to avoid entrapment of air into the product. While stirring, 50 ml of deionized water are added to the composition. The composition is stirred for 4 minutes, until the composition is fully homogeneous. The composition is allowed to rest for 15 minutes before starting the viscosity measurement. The whole procedure is carried out at room temperature.

The viscosity data Vₙ and V_{d} are reported in table 2

TABLE 2

| | | Comparative | Comparative |
|---|---|---|---|
| | 1 | Example A | Example B |
| Undiluted viscosity (Vₙ) | 2700 | 400 | 300 |
| at 20 s⁻¹, cps | | | |
| Diluted Viscosity (V_{d}) | 250 | 315 | 220 |
| at 20 s⁻¹, cps | | | |

The cleaning performance of the Composition 1, Table 1 was tested. The following conditions were used: a Western European horizontal axis washing machine, such as, a Bosch Maxx WFL2450 washing machine manufactured by Bosch Siemens, a water hardness of 2.5 mmoles/liter, a wash temperature of 40 C, regular cotton cycle, a load of 1.5 kg of cotton items, including 16 different stain types. Composition 1 was tested at a dosage of 35 grams/wash, and compared with a commercial sample of Ariel liquid Compact (from Procter & Gamble Ltd.), which was tested at 80 grams/wash, under the same conditions and with the same stains. Both the Composition 1 and the comparative Ariel liquid Compact composition are each placed in their own dosing device such as a commercial dosing ball, and these are placed directly in the washer drum. Then the soiled fabrics are added and the cycle of the washer is started up. At the end of the washes the soiled fabrics washed with Composition 1 and those washed with Ariel liquid were compared by a panel of 2 expert laundry graders, and the resulting stain removal (averaged across all stains) obtained with the two products was judged to be equal.

Other compositions illustrative of the invention are exemplified in Tables 3 and 4

TABLE 3
(% by Weight)

| Ingredients | 2 | 3 |
|---|---|---|
| Alkylbenzenesulfonic acid | 16.0 | 20.0 |
| C12-14 alcohol 7-ethoxylate | 17.5 | 10.0 |
| C12-14 alcohol 3-ethoxylate sulphate, Na salt | — | 10.0 |
| C8-10 Alkylamidopropyldimethyl amine | 2.0 | — |
| Citric acid | 7.0 | 1.5 |
| C12-18 fatty acids | 10.5 | 14.7 |
| Detergent enzymes | 3.1 | 4.0 |
| Ethoxylated polyimine | 1.4 | 1.7 |
| Ethoxylated polyimine polymer, quaternized | 3.7 | 4.3 |
| and sulphated | | |
| Hydroxyethane diphosphonic acids (HEDP) | 2.0 | 1.4 |
| Catechol 2, 5 disulfonate, Na salt | — | 1.3 |
| Fluorescent whitening agent | 0.3 | 0.3 |
| 1,2 propandiol | 4.5 | 4.4 |
| 1-ethoxypentanol | — | 1.0 |
| Monoethanolamine (MEA) | 13.8 | 8.0 |
| MEA borate | — | 0.5 |
| Water | 16.5 | 15.0 |
| Sodium hydroxide | 0.1 | — |
| Hydrogenated castor oil | 0.2 | — |
| Perfume | 1.5 | 1.5 |
| Dyes, minors | balance | balance |
| Viscosity Vₙ (cps) | 6000 | 2700 |
| Viscosity V_{d} (cps) | 720 | 480 |

TABLE 4
(% by Weight)

| Ingredients | 4 | 5 | 6 |
|---|---|---|---|
| Alkylbenzenesulfonic acid | 23.5 | 11.5 | 19.5 |
| C12-14 alcohol 7-ethoxylate | 5.0 | 17.0 | 8.5 |
| C12-14 alcohol 3-ethoxylate sulphate, Na | 10.5 | 7.5 | 9.5 |
| salt | | | |
| C12 alkyl dimethylamine N-oxide | — | — | 2.0 |
| C8-10 Alkylamidopropyldimethyl amine | 1.0 | — | — |
| Citric acid | 1.5 | 3.0 | — |
| C12-18 fatty acids | 15.5 | 11 | 17 |
| Detergent enzymes | 3.1 | 4.0 | — |
| Ethoxylated polyimine | — | 5.0 | 7.5 |
| Ethoxylated polyimine polymer, | 5.0 | — | — |
| quaternized and sulphated | | | |
| Hydroxyethane diphosphonic acids (HEDP) | 1.0 | — | 1.5 |
| Pentamethylene triamine pentaphosphonic | 0.5 | — | — |
| acid | | | |
| s,s-Ethylenediamine disuccinic acid | 2.0 | 3.0 | — |
| Catechol 2, 5 disulfonate, Na salt | — | 1.3 | 3.0 |
| Fluorescent whitening agent | 0.3 | 0.2 | — |
| 1,2 propandiol | 4.5 | — | 2.5 |
| glycerol | — | 5.5 | 2.5 |
| Monoethanolamine (MEA) | 12.5 | 11.5 | 9.5 |
| MEA borate | — | 0.5 | — |
| Water | 10.5 | 15.0 | 15.5 |
| Sodium hydroxide | 0.1 | — | — |
| Hydrogenated castor oil | 0.2 | — | — |
| Perfume | 1.5 | 2.5 | 0.5 |
| Potassium bisulfite | 0.15 | 0.10 | — |
| Dyes, minors | balance | balance | balance |

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

The compositions of the present invention can include, consist essentially of, or consist of, the components of the present invention as well as other ingredients described herein. As used herein, “consisting essentially of” means that the composition or component may include additional ingredients, but only if the additional ingredients do not materially alter the basic and novel characteristics of the claimed compositions or methods. Except as otherwise noted, the articles “a,” “an,” and “the” mean “one or more.”

All percentages stated herein are by weight unless otherwise specified. It should be understood that every maximum numerical limitation given throughout this specification will include every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein. All temperatures are in degrees Celsius (° C.) unless otherwise specified.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An article of commerce for laundering comprising:
(a) a compact fluid laundry composition comprising a sum of water and non-aminofunctional solvent of from about 5% to about 45%, by weight of the composition; and
(b) a water-insoluble container releasably storing said compact fluid laundry detergent composition;
wherein said composition has a neat viscosity, Vₙ, of from about 1,000 cps to about 10,000 cps as measured at 20 s⁻¹, and a diluted viscosity, V_{d}, that is less than or equal to about 0.5Vₙ, as measured at 20 s⁻¹.

2. An article according to claim 1 wherein said laundry composition thins on dilution and wherein said water insoluble container is selected from squeeze containers and pump containers.

3. An article of commerce for laundering comprising:
(a) a compact fluid laundry detergent comprising:
(i) at least about 10%, by weight of the composition, of surfactant;
(ii) at least about 0.05%, by weight of the composition, of perfume;
(iii) from about 1% to about 30%, by weight of the composition, of water;
(iv) from about 1% to about 15%, by weight of the composition, of non-aminofunctional solvent;
provided the sum of said water and said non-aminofunctional solvent, by weight of the composition, is from 5% to no more than 45% by weight of the composition, and said composition has a neat viscosity, Vₙ, of from about 1000 cps to about 10,000 cps as measured at 20 s⁻¹, and a diluted viscosity, V_{d}, that is less than or equal to about 0.5Vₙ, as measured at 20 s⁻¹; and
(b) a water insoluble container in direct contact with and releasably storing said compact fluid laundry detergent composition.

4. The article of commerce of claim 3 wherein said compact fluid laundry detergent comprises from about 5% to about 30%, by weight of the composition, of said water.

5. The article of commerce of claim 4 wherein said compact fluid laundry detergent is internally structured by the surfactant.

6. The article of commerce of claim 5 wherein the surfactant is selected from an anionic surfactant, soap, and mixtures thereof, and said surfactant have a cation selected from sodium, potassium, an aminofunctional cation and combinations thereof; and said surfactant comprises less than about 5% by weight of the composition of amine oxide and/or betaine.

7. The article of commerce according to claim 3 wherein said compact fluid laundry detergent comprises an adjunct selected from pearlescents, opalescents, chelants, polymers, enzymes, enzyme inhibitors, brighteners, builders, dye transfer inhibitors, dyes, dye color fidelity stabilizers, bleach catalysts and/or bleach boosters, bleach activators, buffers, antimicrobial agents, UV absorbers, fabric softening additives, suds boosters, suds suppressors, dispersing agents, processing aids, soil release polymers, neutralizers, hydrotropes, thickeners, structurants and mixtures thereof.

8. The article of commerce according to claim 3 wherein said water insoluble container is selected from top dispensing containers, bottom dispensing containers, side dispensing containers, and combinations thereof.

9. The article of commerce according to claim 3 wherein said water insoluble container comprises:
a deformable container for storing said compact fluid laundry detergent, said deformable container having a bottom end and an opening in said bottom end; and
a dispensing cap, removably attached to said bottom end of said deformable container and covering at least said opening in said bottom end.

10. The article of commerce according to claim 3 wherein said water insoluble container is selected from opaque, transparent/translucent and combinations thereof.

11. Use of the article of commerce according to claim 3 for dispensing a premeasured dose of detergent and for laundering fabrics therewith.

12. Use of the article of commerce according to claim 3 in conjunction with a dispensing device for dispensing a variable dose of detergent and for laundering fabrics therewith, wherein said dispensing device is detachably mounted on said container.

13. A method of ensuring dose compliance on dosing a compact fluid laundry detergent, said method comprising providing the article of commerce according to claim 3 wherein said container or a dosing ball for use therewith has markings to provide fractions of a recommended dose such that a specified numbers of fractions of the recommended dose are to be used for laundering in hard, medium and soft water.

14. An article of commerce for laundering, storing and dispensing liquid compositions in contact therewith, comprising:
(a) a compact fluid laundry detergent composition comprising:
(i) from about 20% to about 50%, by weight of the composition of surfactant selected from anionic surfactant, nonionic surfactant and mixtures thereof;
(ii) from about 0.05% to about 3%, by weight of the composition, perfume;
(iii) from about 5% to about 30%, by weight of the composition, water;
(iv) from about 3% to about 10%, by weight of the composition, of non-aminofunctional solvent;
(v) from about 7% to about 20%, by weight of the composition, soap; and
(vi) from about 0% to about 1%, by weight of the composition, of hydrotropes and/or externally structuring thickeners;
(vii) from about 0% to about 5%, by weight of the composition, of amine oxide and/or betaine;
wherein the sum of said water and said non-aminofunctional solvent is from about 15% to 35% by weight of the composition, and said compact fluid laundry detergent has a neat viscosity, Vₙ, of from about 1000 cps to about 10,000 cps as measured at 20 s⁻¹, and a diluted viscosity, V_{d}, that is less than or equal to about 0.5Vₙ, as measured at 20 s⁻¹; and
(b) a water insoluble container in direct contact with and releasably storing said compact fluid laundry detergent composition;

15. The article of commerce according to claim 14 wherein said water insoluble container comprises a polymeric material is selected from polypropylene, biodegradable plastics, polyethylene, polycarbonate, polyamide, polyethylene terephthalate, polyvinylchloride, polystyrene, and mixtures thereof.

16. The article of commerce according to claim 14 wherein said non-aminofunctional solvent is selected from C₁-C₅ alkanols, C₂-C₆ diols, C₃-C₈ alkylene glycols, C₃-C₈ alkylene glycol mono lower alkyl ethers, lower molecular weight polyethylene glycols, C3-C9 triols and mixtures thereof.

17. The article of commerce according to claim 14 wherein said compact fluid laundry detergent comprises an adjunct selected from, pearlescents, opalescents, chelants, polymers, enzymes, enzyme inhibitors, brighteners, builders, dye transfer inhibitors, dyes, dye color fidelity stabilizers, bleach catalysts and/or bleach boosters, bleach activators, buffers, antimicrobial agents, UV absorbers, fabric softening additives, suds boosters, suds suppressors, dispersing agents, processing aids, soil release polymers, neutralizers, structurants and mixtures thereof.

18. The article of commerce according to claim 14 wherein said soap is at least partially in alkanolammonium salt form.

19. The article of commerce according to claim 14 wherein said anionic surfactant is selected from alkyl benzene sulfonates, alkyl alkoxysulfates, and mixtures thereof.

20. The article of commerce according to claim 14 wherein said compact fluid laundry detergent composition is substantially free of amine oxides.
